(19) United States
(12) Patent Application Publication
(10) Pub. No.: US 2009/0254641 A1
(43) Pub. Date: Oct. 8, 2009

(54) NETWORK CARD CAPABLE OF REMOTE BOOT AND METHOD THEREOF

(75) Inventors: Wei LIU, Tianjin (CN); Yun-Song WANG, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/061,544

(22) Filed: Apr. 2, 2008

(51) Int. Cl. G06F 15/177; G06F 9/00

(52) U.S. Cl. 709/222; 713/2

(57) ABSTRACT

A network card capable of remote boot and method thereof. The network card, installed on a client which connects to a server via internet and receives a plurality of boot image files from the server for booting the client. Then, a plurality of boot image files is received from the server, so as to boot the client. A linking device includes a virtual disk control module, a network storage device, and a network communication module. The virtual disk control module is used to provide a virtual disk, and to link the virtual disk to a remote disk of the server. The network storage device is used to receive bootstrap information sent by the server. The network communication module is used to establish a relevant network communication with the server. Therefore, meanwhile as the client is booted, the network card can initialize a virtual disk for booting the client.

### BACKGROUND OF THE INVENTION

1. Field of the Invention

The present invention relates to a remote boot support network card and a method thereof, and more particularly to a network card and a method thereof, in which a virtual disk is loaded to a server during the boot, then the server is connected to a remote disk according to bootstrap information of the virtual disk, so as to receive boot image files required by the bootstrap program at the client.

2. Related Art

As the network transmission speed becomes increasingly high, the application of the network is no longer restricted to browsing websites or transmitting data. Someone further proposes to use the current network architecture to configure a network computer. As for the network computer, no storage devices are disposed in the client, instead, the client links to the server over network, and then the data required for the operation of the client is captured from the server.

Generally, the disks linking to the remote end through network adopt a preboot execution environment (hereinafter referred to as PXE for short). Besides retrieving the data of the server to support the boot of the client, PXE can further install the system or applications at the client through using the server. Generally, in order to realize the above function of remote operation, the PXE is burnt to a flash memory on the network card. Once the client is booted, the PXE links the client to the server according to the address for the network card of the server received by the client.

Referring to FIG. 1, it is a flow chart of a conventional PXE linking operation.

Firstly, once the client is booted, the boot ROM in the network card performs self test before acquiring a control authority, and then sends a request message in a broadcasting mode (Step S110).

If receiving the request sent by the client, the server returns an acknowledgement message to the client (Step S120). The acknowledgement message includes a preset communication channel and boot image files. The preset communication channel is used for confirming relevant information such as the network protocol or connection port for the link between the client and the server. The boot image files are boot system files required by the client.

Once receiving the acknowledgement message returned from the server, the client sends a response message for informing the server to start transmitting the boot image files required by the client for booting (Step S130). Then, the boot image files supporting the boot of the client are loaded from the server (Step S140). After receiving all the boot image files, the client bootstraps the operating system to be booted according to the boot image files (Step S150).

Although the PXE can be used to install or execute the system for the client at the remote end, PXE has a lot of inconveniences in usage. The disadvantages in the usage of the PXE are listed as follows. 1. The network card must support the PXE; otherwise, it cannot start relevant functions. 2. The PXE seldom supports the TCP/IP layer, and fails to support the fiber communication protocol. 3. The PXE requires the user to define a network bootstrap program (NBP) manually to amend an interrupt vector table. 4. The PXE protocol is based upon network equipments, and as a result, the PXE cannot be adopted by other types of equipments.

### SUMMARY OF THE INVENTION

In view of the above problems, the present invention is mainly directed to a network card, installed on a client which connects to a server via internet and receives a plurality of boot image files from the server for booting the client.

As embodied and broadly described herein, the present invention provides a remote boot support network card, which includes a virtual disk control module, a network storage device, and a network communication module. The virtual disk control module is used to provide a virtual disk, and to link the virtual disk to a remote disk of the server. The network storage device is used to receive bootstrap information sent by the server. The network communication module is used to establish a relevant network communication with the server.

From another aspect of the present invention, the present invention provides a method for supporting remote boot, in which a network card is disposed at a client, so as to link the client to the server over internet; and then, a plurality of boot image files is received from the server, so as to boot the client.

As embodied and broadly described herein, the method of remote boot support network in the present invention includes the following steps: initializing a virtual disk in a startup memory of the network card; registering the virtual disk to a basic input output system (hereinafter referred to as BIOS for short); linking to a server over network according to a link information in the virtual disk; loading a plurality of bootstrap information from the server to a network storage device of the client; and then performing a bootstrap program on the client according to the bootstrap information.

According to an embodiment of the present invention, in the above method and system, a virtual disk is partitioned in the startup memory of the network card. Meanwhile, when the client is booted, the virtual disk is registered to the BIOS of the client, so as to boot the client through the virtual disk. During the booting process, the network card links to the remote disk in the server, and duplicates the boot image files in the remote disk to the virtual disk. The present invention loads the registration of the virtual disk when booting the client, and loads the boot image files from the server to the virtual disk. Therefore, it does not require an operating system to configure the virtual disk.

### BRIEF DESCRIPTION OF THE DRAWINGS

The present invention will become more fully understood from the detailed description given herein below for illustration only, which thus is not limitative of the present invention, and wherein:

FIG. 1 is a flow chart of a conventional PXE connecting operation;

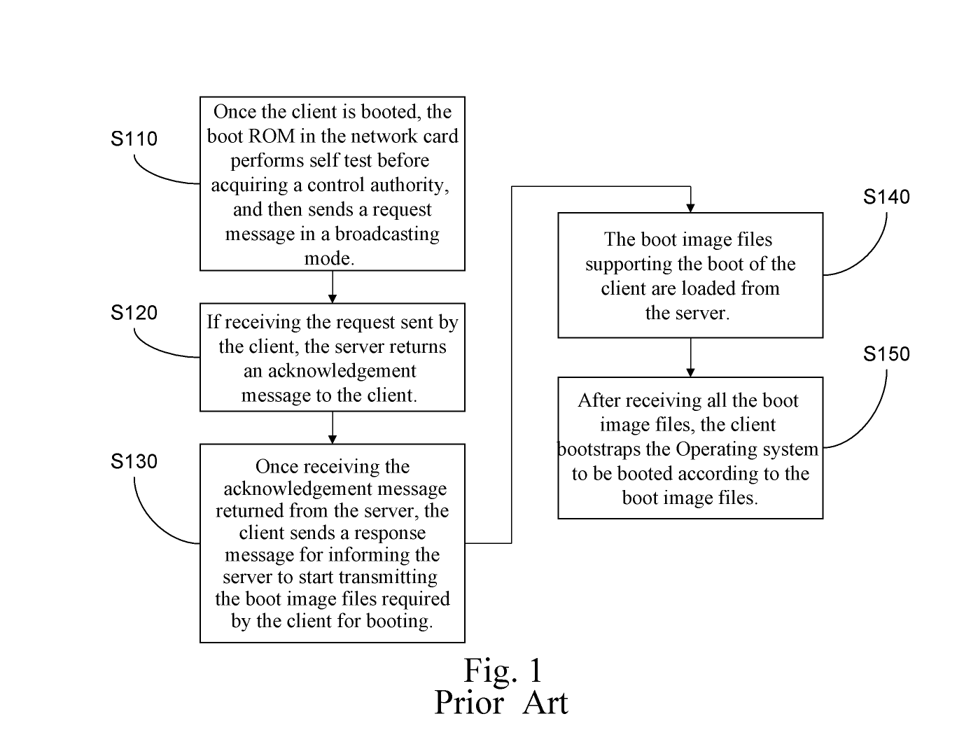

FIG. 2 is a schematic view of system architecture of the present invention;

FIG. 3 is a flow chart of an operation according to the present invention;

FIG. 4 is a schematic view of a connection between a virtual disk and a remote disk according to the present invention; and

FIG. 5 is an architectural diagram of a redundant optic fiber disk array including the network card of the present invention.

### DETAILED DESCRIPTION OF THE INVENTION

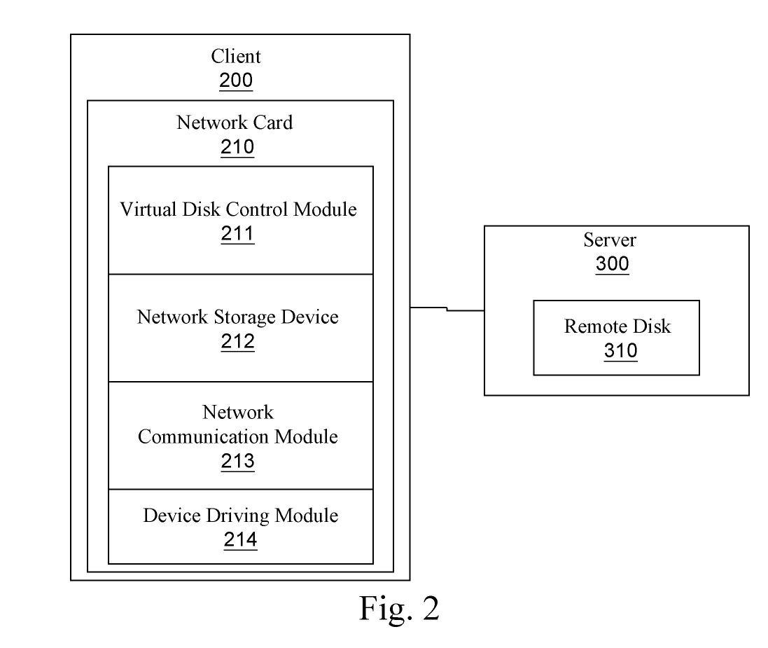

Referring to FIG. 2, it is a schematic view of system architecture of the present invention. The present invention provides a network card capable of remote boot. When a client 200 is booted, a network card 210 of the client 200 provides a virtual disk, and the network card 210 links to a remote disk 310 in the server 300. The network card 210 of the present invention includes: a virtual disk control module 211, a network storage device 212, a network communication module 213, and a device driving module 214.

The virtual disk control module 211 is stored in a startup memory (option ROM) of the network card 210 and it is used for providing a virtual disk. The virtual disk control module 211 links to a remote disk 310 in the server 300, and duplicates the boot image files in the remote disk 310 to the virtual disk.

The network storage device 212 is used to receive the boot image files sent by the server 300. After the network storage device 212 finishes loading the remote disk 310, the virtual disk is registered to the BIOS of the client 200. The registration motion to the BIOS of the client is the same as that of other storage devices, and through such a registration motion, the BIOS considers that the virtual disk is located in the client 200. After all the storage devices have already been initialized, the BIOS may perform a booting motion according to the set disk.

In the present invention, it is set to boot from the virtual disk provided by the virtual disk control module 211. The network communication module 213 is used to provide a network communication protocol for communicating with the server 300. In this embodiment, the network communication protocol may be, but not limited to, transmission control protocol (TCP), fiber channel over IP (FCIP), internet small computer system interface (iSCSI), or internet fiber channel protocol (iFCP). The device driving module 214 is used to control a plurality of storage devices of the client 200, and the storage devices may be a register or a memory.

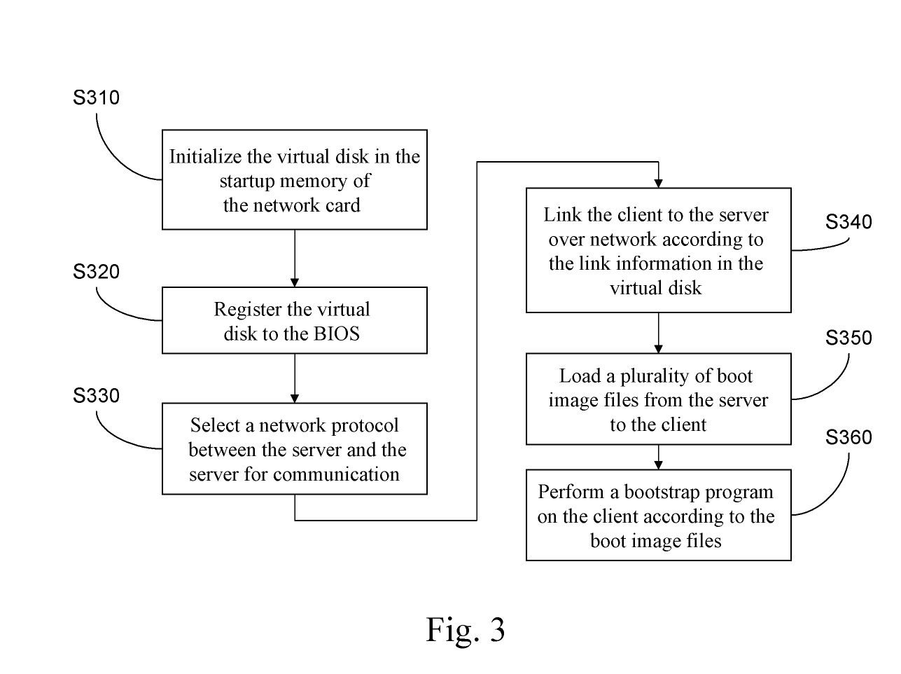

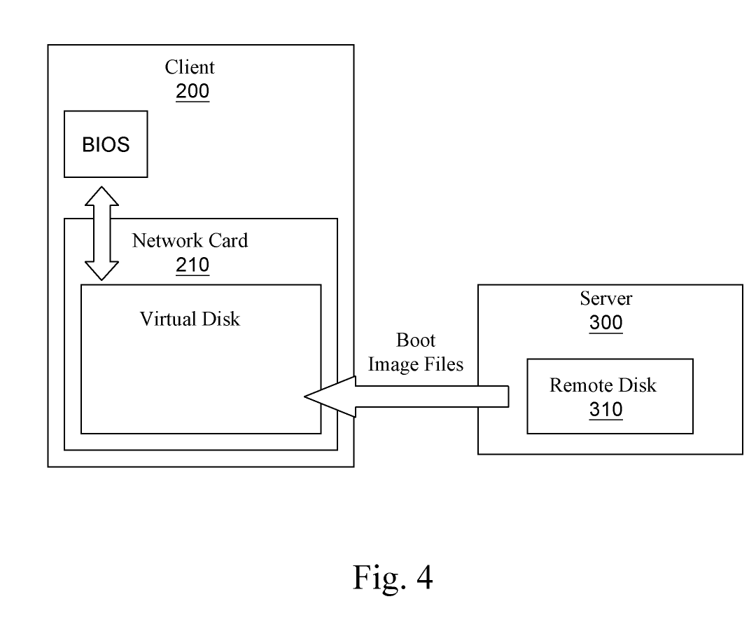

In order to further illustrate the operation flow of each element in the present invention clearly, referring to FIG. 3, it is a flow chart of an operation according to the present invention, which includes: firstly, initializing the virtual disk in the startup memory of the network card (Step S310); next, registering the virtual disk to the BIOS (Step S320); then, selecting a network protocol between the server and the server for communication (Step S330); then, linking the client to the server over network according to the link information in the virtual disk (Step S340); then, loading a plurality of boot image files from the server to the network storage devices of the client (Step S350); and then, performing a bootstrap program on the client according to the boot image files (Step S360). Meanwhile, referring to FIG. 4, it is a schematic view of a connection between a virtual disk and a remote disk according to the present invention. The subsequent booting process is the same as that of the conventional bootstrap program, which thus is not repeated herein.

Besides the common network controller, the present invention can be further applied on other storage controllers. For example, in a redundant array of independent disks (hereinafter referred to as RAID for short), by means of combining the present invention with an RAID controller, the client 200 can perform the RAID without physical disks.

The difference between the present invention and the PXE lies in that, the motion of registering the virtual disk in the present invention is performed along with the initialization of the network card 210, but the PXE requires the operating system to start up the virtual disk. According to an embodiment of the present invention, in the above method and system, a virtual disk is partitioned in the startup memory of the network card 210. When the client 200 is booted, the virtual disk is registered to the BIOS of the client 200, such that the client 200 is booted from the virtual disk. Meanwhile as the client 200 is booted, the network card links to the remote disk 310 in the server 300, and duplicates the boot image files in the remote disk 310 to the virtual disk. The present invention loads the registration of the virtual disk when the client 200 is booted, and loads the boot image files from the server 300 to the virtual disk. In this way, it does not require an operating system to configure the virtual disk.

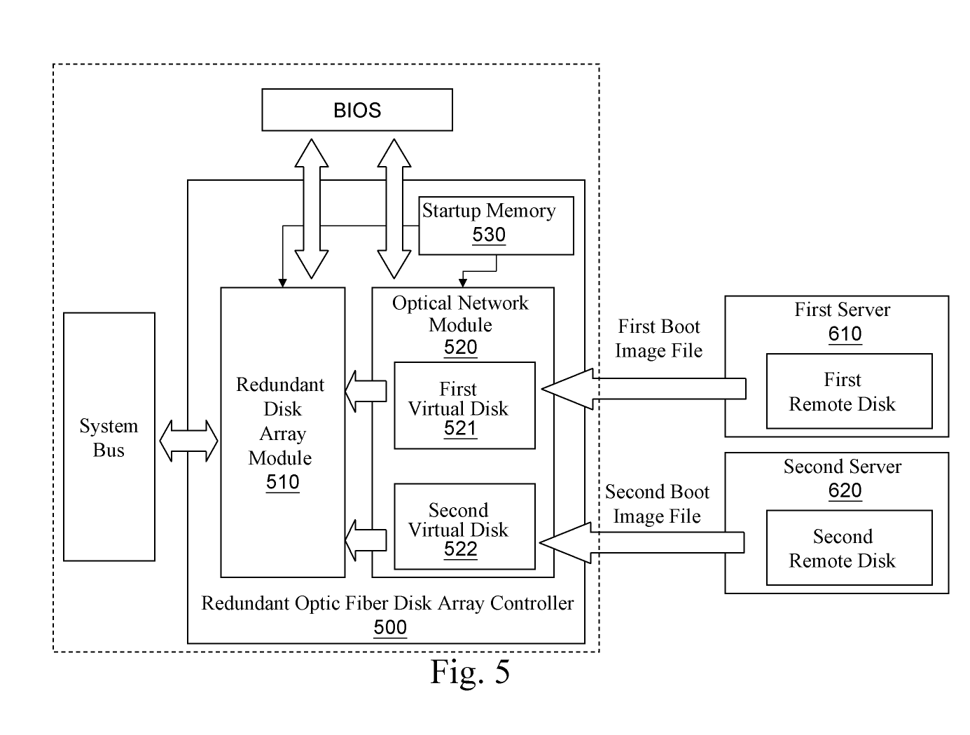

In order to further illustrate the applications of the present invention clearly, an example of combining the redundant optic fiber disk array controller with the present invention is provided below. Referring to FIG. 5, it is an architectural diagram of a redundant optic fiber disk array including the network card of the present invention, together referring to the operation flow as shown in FIG. 3. The redundant optic fiber disk array controller 500 includes: a redundant disk array module 510, an optical network module 520, and a startup memory 530. The optical network module 520 is used to generate a virtual disk corresponding to the sever in the optical network module through a virtual program stored in the startup memory 530. The redundant optic fiber disk array controller 500 at least links to a first server 610 and a second server 620. Therefore, a first virtual disk 521 and a second virtual disk 522 are correspondingly generated in the optical network module. Besides, when more than two servers are linked, a corresponding number of virtual disks are generated.

Firstly, the virtual disk is initialized in the startup memory 530. Next, the virtual disk is registered to the BIOS, and the redundant disk array module 510 gets the relevant information such as the address of the virtual disk from the BIOS and takes such information as the actually-connected disk for being provided to the BIOS. Then, a plurality of boot image files is loaded from the server to the network storage devices of the client. Then, the first server 610 transmits a first boot image file to the virtual disk 521, and the second server 620 transmits a second boot image file to the second virtual disk 522. The redundant optic fiber disk array controller 500 decides to select the data from which virtual disk according to the bootstrap program set by the system.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A network card, installed on a client which connects to a server via internet and receives a plurality of boot image files from the server for booting the client, the network card comprising:
a virtual disk control module, disposed in a startup memory of the network card, for providing a virtual disk, and linking the virtual disk to a remote disk of the server;
a network storage device, for receiving boot image files sent by the server; and
a network communication module, for establishing a relevant network communication with the server.

2. The network card according to claim 1, further comprising:
a device driving module, for controlling operations of a plurality of storage devices of the server.

3. The network card according to claim 2, wherein the storage devices comprise a register or a memory.

4. The network card according to claim 1, wherein the network communication module adopts any one of transmission control protocol (TCP), fiber channel over IP (FCIP), internet small computer system interface (iSCSI), or internet fiber channel protocol (iFCP).

5. A method of remote boot support network, wherein the network card is disposed in a client, and the client links to a server over internet and receives a plurality of boot image files from the server, so that the client is booted, the method for remote boot comprising:
initializing a virtual disk in a startup memory (option ROM) of the network card;
registering the virtual disk to a basic input output system (BIOS);
linking to a server over internet according to a link information in the virtual disk;
loading a plurality of bootstrap information from the server to the client; and
performing a bootstrap program on the client according to the bootstrap information.

6. The method of remote boot support network according to claim 5, wherein the step of linking to the server adopts any one of transmission control protocol (TCP), fiber channel over IP (FCIP), internet small computer system interface (iSCSI), or internet fiber channel protocol (iFCP).

7. The method of remote boot support network according to claim 5, wherein the step of linking to the server over internet further comprises: selecting a network protocol between the server and the server for communication.
